(19) United States
(12) Patent Application Publication
(10) Pub. No.: US 2011/0124820 A1
(43) Pub. Date: May 26, 2011

(54) SUPRAMOLECULAR STRUCTURE OF HAVING SUB-NANO SCALE ORDERING

(76) Inventors: Jae-Suk Lee, Gwangji-City (KR); Changej Mohammad, Gwangju-City (KR); Haeng-Deog Koh, Gwangju-City (KR); Samal Shashadhar, Gwangju-City (KR); Nam-Goo Kang, Gwangju-City (KR); Won-Jung Shin, Gwangju-City (KR); Young-Jae Kim, Gwangju-City (KR)

(21) Appl. No.: 12/992,534

(22) PCT Filed: May 15, 2008
(86) PCT No.: PCT/KR08/02718

§ 371 Date: Feb. 7, 2011

(51) Int. Cl. C08F 226/06

(52) U.S. Cl. 525/280; 525/540; 525/327.1

(57) ABSTRACT

Provided is a crystalline organic polymer in which a main chain formed of amorphous polymer or monomer having a functional group is combined with a side chain by quaternization, cross-linking, hydrogen bonding or organic material-metal interaction. The main chain material having a functional group is combined with the side chain material to have crystallinity, and the organic polymer having crystallinity exhibits excellent diode characteristics.

### TECHNICAL FIELD

The present invention relates to a nano-crystalline structure of an organic material and a method of forming the structure, and more particularly, to a nano-crystalline structure formed by quaternization, cross-linking, hydrogen bonding or metal coordination between a main chain material composed of a block copolymer, a homopolymer or a monomer, and a side chain material, to obtain electrical characteristics.

### BACKGROUND ART

Research has been conducted into pattern structures on the scale of micrometers down to tens of nanometers, and their crystallization based on phase separation or self-assembly of a block copolymer. For this research, a block copolymer having an amphiphilic (hydrophilic and hydrophobic) group or a polymer having crystallinity has been used as a raw material.

Recent developments in the preparation of a crystalline polymer have focused on an interaction between a main chain and a side chain, but little progress has been made toward controlling a crystalline structure.

### DISCLOSURE

### Technical Problem

The present invention is directed to an organic polymer having crystallinity and capable of being used as an organic semiconductor device.

### Technical Solution

One aspect of the present invention provides an organic crystalline polymer including a main chain material having a functional group enabling quaternization, organic material-metal interaction or hydrogen bonding, and a side chain material combining with the functional group in the adjacent main chain material by quaternization, cross-linking, organic material-metal interaction or hydrogen bonding.

Another aspect of the present invention provides an organic crystalline polymer including a main chain having a functional group containing nitrogen, sulfur or selenium with an unshared electron pair, and a side chain material combined with the functional group in the adjacent main chain material by quaternization, cross-linking, organic material-metal interaction or hydrogen bonding.

### Advantageous Effects

According to the present invention, a side chain material is introduced into a main chain material such as various types of polymers or monomers by quaternization, cross-linking, hydrogen bonding or metal-organic material/polymer coordination. By an interaction between the main chain material and the side chain material, a uniform crystalline structure of several nanometers in size can be obtained. Further, when this structure is embodied as a device, the device exhibits ideal diode characteristics. That is, this structure can be employed in organic electrical devices, for example, devices formed of organic semiconductor, and thus can be utilized as a variety of electronic materials.

### DESCRIPTION OF DRAWINGS

FIG. 1 shows a high-resolution transmission electron microscope (HR-TEM) image of a nano crystalline structure of a polymer micelle cross-linked with 1,4-dibromobutane in poly(2-vinylpyridine)-block-poly(hexylisocyanate) (P2VP-b-PHIC) according to a first exemplary embodiment of the present invention;

FIG. 2 shows (a) a Fast Fourier Transform (FFT) image and (b) a processed FFT image of the nano crystalline structure of the polymer micelle cross-linked with 1,4-dibromobutane in P2VP-b-PHIC according to the first exemplary embodiment of the present invention;

FIG. 3 shows an X-ray diffraction (XRD) result of the nano crystalline structure of the polymer micelle cross-linked with 1,4-dibromobutane in P2VP-b-PHIC according to the first exemplary embodiment of the present invention;

FIG. 4 shows TEM images of a nano crystalline structure of a polymer micelle quaternized with 1-bromobutane in P2VP-b-PHIC dispersed in a mixed solvent of methanol and toluene in a volume ratio of 8:2 according to the first exemplary embodiment of the present invention, ((a) scale bar: 500 nm, (b) scale bar: 10 nm, (c) enlarged image of (b));

FIG. 5 shows a density distribution of fringe spacings of the nano crystalline structure of the polymer micelle quaternized with 1-bromobutane in P2VP-b-PHIC dispersed in a mixed solution of methanol and toluene in a volume ratio of 8:2 according to the first exemplary embodiment of the present invention;

FIG. 6 shows TEM images of a polymer film quaternized with 1,4-dibromobutane in P2VP-b-PHIC dispersed in a THF solvent in a concentration of 0.1 to 1 mg/ml, wherein (a) is an energy-filtering TEM (EF-TEM) image and an XRD result, and (b) is an HR-TEM image and a density distribution of fringe spacings of a polymer nano crystalline structure;

FIG. 7 shows an XRD result of the polymer film quaternized with 1,4-dibromobutane in P2VP-b-PHIC dispersed in a THF solvent in a concentration of 0.1 to 1 mg/ml;

FIG. 8 shows (a) an HR-TEM image, (b) a high-powered HR-TEM image, and (c) a density distribution of fringe spacings of a nano crystalline structure of a polymer micelle cross-linked with 75 mole % of 1,4-dibromobutane, based on the mole of a vinyl pyridine unit of the P2VP-b-PHIC, in P2VP-b-PHIC;

FIG. 9 shows (a) an HR-TEM image, (b) a high-powered HR-TEM image, and (c) a density distribution of fringe spacings of a nano crystalline structure of a polymer micelle cross-linked with 50 mole % of 1,4-dibromobutane, based on the mole of a vinyl pyridine unit of the P2VP-b-PHIC, in P2VP-b-PHIC;

FIG. 10 shows (a) an HR-TEM image, and (b) a high-powered HR-TEM image of a nano crystalline structure of a polymer micelle cross-linked with 1,4-dibromobutane in poly(2-vinylpyridine)-block-polystyrene (P2VP-b-PS) dispersed in a mixed solution of methanol and THF in a volume ratio of 8:2 according to the first exemplary embodiment of the present invention;

FIG. 11 shows a density distribution of fringe spacings of the nano crystalline structure of the polymer micelle cross-linked with 1,4-dibromobutane in P2VP-b-PS dispersed in a mixed solution of methanol and THF in a volume ratio of 8:2 according to the first exemplary embodiment of the present invention;

FIG. 12 shows (a) an HR-TEM image, and (b) a high-powered HR-TEM image of a nano crystalline structure of a polymer micelle cross-linked with 1,4-dibromobutane in P2VP-b-PS dispersed in a mixed solution of toluene and methanol in a volume ratio of 8:2 according to the first exemplary embodiment of the present invention;

FIG. 13 shows a density distribution of fringe spacings of the nano crystalline structure of the polymer micelle cross-linked with 1,4-dibromobutane in P2VP-b-PS dispersed in a mixed solution of toluene and methanol in a volume ratio of 8:2 according to the first exemplary embodiment of the present invention;

FIG. 14 shows an XRD result of the nano crystalline structure of the polymer micelle cross-linked with 1,4-dibromobutane in P2VP-b-PS dispersed in a mixed solution of toluene and methanol in a volume ratio of 8:2 according to the first exemplary embodiment of the present invention;

FIG. 15 shows an AFM image of a polymer film cross-linked with 1,4-dibromobutane in a poly(vinylphenylpyridine)-block-poly(2-vinylpyridine) (PP2VP-b-P2VP) block copolymer dispersed in a THF solvent according to the first exemplary embodiment of the present invention;

FIG. 16 shows an HR-TEM image and a diffraction result of the polymer film cross-linked with 1,4-dibromobutane in a poly(vinylphenylpyridine)-block-poly(2-vinylpyridine) (PP2VP-b-P2VP) block copolymer dispersed in a THF solvent according to the first exemplary embodiment of the present invention;

FIG. 17 shows an HR-TEM image and a diffraction image of a nano crystalline structure of a monomer film in which poly(2-vinylpyridine) dispersed in a methanol solvent is cross-linked with hydroquinone by hydrogen bonding according to a second exemplary embodiment of the present invention;

FIG. 18 shows an FFT image of the HR-TEM image and a density distribution of fringe spacings of the nano crystalline structure of the monomer film in which poly(2-vinylpyridine) dispersed in a methanol solvent is cross-linked with hydroquinone by hydrogen bonding according to the second exemplary embodiment of the present invention;

FIG. 19 shows an HR-TEM image of a nano crystalline structure of a monomer film cross-linked with 1,4-dibromobutane in 2,2-bipyridine dispersed in a dimethylformamide (DMF) solvent according to the second exemplary embodiment of the present invention;

FIG. 20 shows an FFT image of the HR-TEM image and an enlarged result of the nano crystalline structure of the monomer film cross-linked with 1,4-dibromobutane in 2,2-bipyridine dispersed in a dimethylformamide (DMF) solvent according to the second exemplary embodiment of the present invention;

FIG. 21 shows an EF-TEM image of a rod-shaped polymer film in which polyaniline is cross-linked with chlorozinc (ZnCl₂) by metal-polymer coordination according to a third exemplary embodiment of the present invention;

FIG. 22 shows an FFT image of an HR-TEM image of the rod-shaped polymer film in which polyaniline is cross-linked with ZnCl₂ by metal-polymer coordination according to a third exemplary embodiment of the present invention;

FIG. 23 shows a technique of measuring electrical characteristics of a polymer film having an organic crystalline structure formed according to the present invention; and

FIG. 24 is a graph of electrical characteristics of an organic single crystalline polymer according to a fourth exemplary embodiment of the present invention.

### MODE FOR INVENTION

Hereinafter, exemplary embodiments of the present invention will be described in detail with reference to the accompanying drawings.

In the exemplary embodiments of the present invention, a polymer crystalline structure includes at least one of the compositions of Formulae 1 to 12 as a main chain.

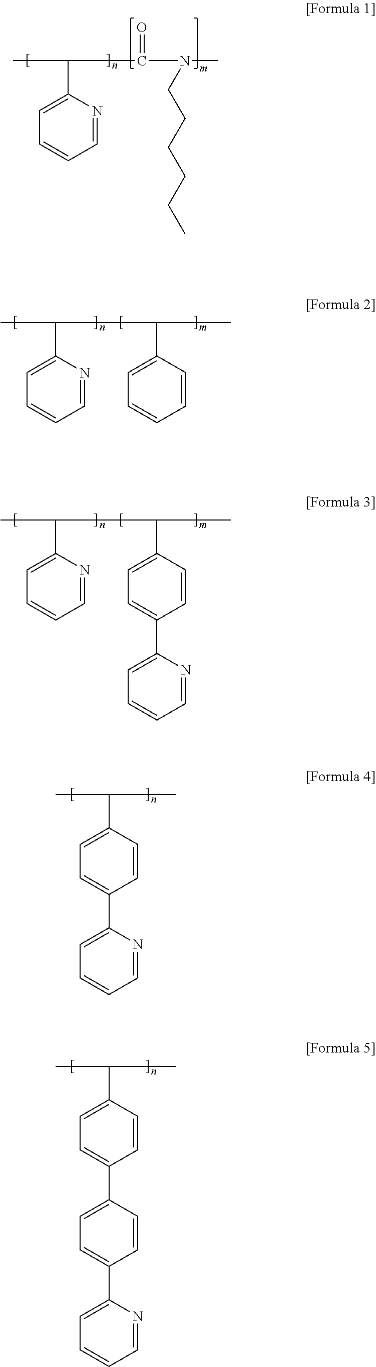

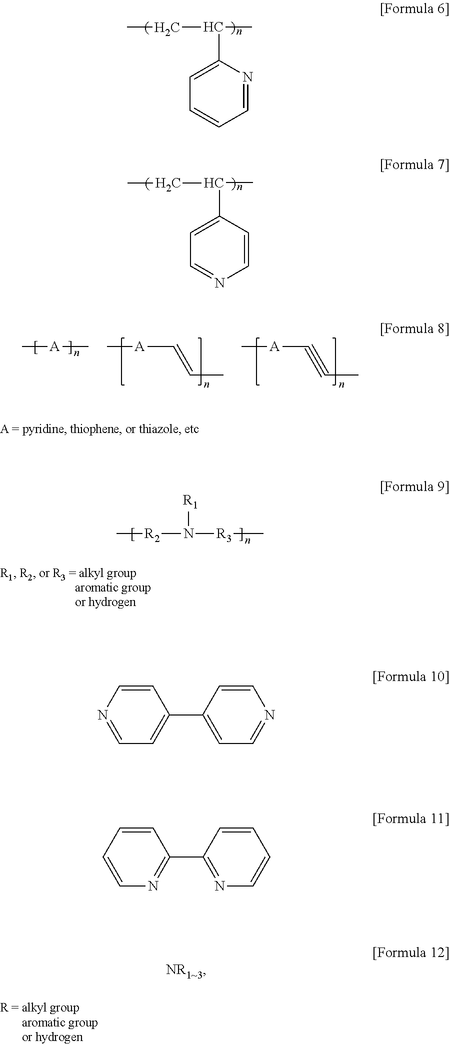

Formulae 1 to 3 are block copolymers used as a main chain of a polymer crystalline structure according to the present embodiment.

Formulae 4 to 9 are homopolymers used as a main chain of a polymer crystalline structure according to the present embodiment.

Formulae 10 to 12 are organic monomers used as a main chain of a polymer crystalline structure according to the present embodiment.

The main chain materials of Formulae 1 to 7, 10 and 11 include pyridines as functional groups. In addition, pyrroles or thiophenes are used as the functional groups.

For example, the functional groups capable of being employed in the compositions of Formulae 1 to 7, 9 and 10 include pyridines such as pyridine, pyridazine, pyrimidine, triazine, tetrazine, oxazine, thiazine and selenazine; pyrolles such as pyrrole, pyrazole, imidazole, dihydrothiazole, dihydrooxazole, dihydroselenazole, triazole, dihydrooxadiazole, dihydrothiadiazole and dihydroselenadiazole; and thiophenes such as thiophene, isothiazole, thiazole, dithiole, oxathiole, thiaselenole, thiadiazole, oxathiazole, dithiazole and thiaselenazole.

That is, any aromatic group containing an atom with an unshared electron pair such as nitrogen, sulfur or selenium can serve as the functional group of the main chain material. Further, while the functional group is included in a side chain formed by a polymerization method using vinyl groups of Formulae 1 to 7 in the present embodiment, all functional groups listed above may be properly arranged in the main chain as in Formula 12 in an alternative embodiment.

Furthermore, in the present embodiment, one of the groups of Formulae 14 to 18 is used as a side chain material on the basis of ranges of the side chain materials which enable cross-linking, quaternization, metal-organic material/polymer coordination and hydrogen bonding, as in Formula 13 below.

While the crystalline structures are formed using organic monomers and metals as a side chain material in the present embodiment, the crystalline structures may be formed using the main chain materials of Formulae 1 to 12 and side chain materials such as vinyl homopolymer and block copolymer having Cl, Br, I, OH and COOH groups as a functional group by cross-linking, quaternization and hydrogen bonding in alternative embodiments.

That is, the main chain material is bound with the side chain material by cross-linking, quaternization, metal-organic material/polymer coordination or hydrogen bonding to form a crystalline structure.

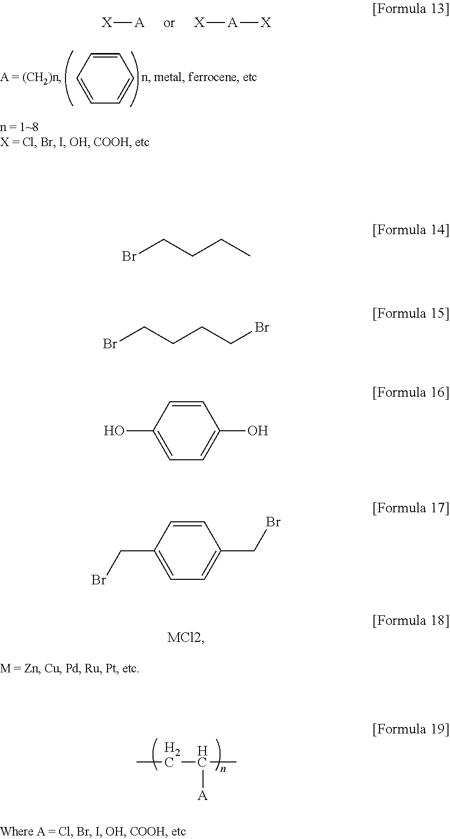

The side chain material of Formula 19 may be formed of a vinyl homopolymer, which may be employed as one block to form a block copolymer.

A ratio of n to m of the block copolymers of Formulae 1 to 3 satisfies the condition of 0<n/(n+m)<1. The ratio is preferably in the range from 0.1 to 0.9, and more preferably, from 0.3 to 0.7. Also, the block copolymers may have a micelle structure.

In the present embodiment, after conditions are formed for building a micelle- or film-type nano structure using block copolymers, homopolymers or monomers of Formulae 1 to 12 for a main chain in a selective solvent, a side chain material of Formulae 13 to 18 is introduced into the solution, so as to form an organic polymer crystalline structure through cross-linking, quaternization, organic material-metal interaction or hydrogen bonding.

Various electrical characteristics can be obtained using the nano structure whose crystalline structure is differently controlled on a scale of nanometers according to a variety of concentrations and fractions of the main chain and side chains.

The nano crystalline structure thus built is analyzed using transmission electron microscopes (FE-TEM and FE-SEM), atomic force microscopes (AFM), dynamic light scattering and x-ray diffraction (XRD) equipment. Finally, an electronic device is created using the crystallized polymer nano structure, and its electrical characteristics are estimated.

In the present embodiment, methods of forming and controlling a several nanometer-sized nano structure formed in uniform arrangement by combination between polymers or monomers for the main chain, and side chain materials capable of quaternization, cross-linking, organic material-metal coordination or hydrogen bonding will be descried in detail. However, homopolymers such as poly(vinylpyridine) (P2VP), poly(vinylphenylpyridine) (PP2VP) and poly(vinylbiphenylpyridine) (PPP2VP) also can be used for the main chain, and various organic and metal materials having a functional group capable of polar-polar interaction with the main chain can be used for the cross-linkable side chain. Although the block copolymers, homopolymers and monomers having pyridines are used as the main chain material in the present embodiments, materials having functional groups capable of forming quaternization, cross-linking, organic material-metal bonding and hydrogen bonding with the side chain, e.g., thiophene and thiazole groups, also may be used as the main chain material. The present invention will now be described in more detail with reference to specific exemplary embodiments, which are not intended to limit the scope of the invention.

### Example 1

### Formation of Organic Crystalline Structure Using Block Copolymer

An amount of a side chain cross-linking with a block copolymer main chain of Formulae 1, 2 or 3 was 50, 75 or 100 mole % based on the vinyl pyridine unit from poly(2-vinylpyridine) of the block copolymer. The block copolymer was dissolved in a selective organic solvent, the cross-linking agent was dispersed in the solution in a calculated molar ratio, and the solution was agitated to form sufficient cross-links.

First, the block copolymer listed above was dissolved in a selective solvent. The organic solvent was a common organic solvent, specifically, methanol, tetrahydrofurane (THF), or a mixture thereof. The block copolymer was dissolved in the solvent to a concentration of from 0.5 to 10 g/l. Here, the block copolymer was dissolved at a temperature ranging from 15 to 40° C., and preferably 20 to 30° C., for about 10 hours by agitation.

The 50, 75 and 100 mole % cross-linking agents, calculated by considering the mole of the vinylpyridine unit, were dispersed in the micelle-type polymer solution prepared from the block copolymer by the above method and agitated for 24 to 180 hours depending on the kind of the cross-linking agent.

In the present embodiment, coil-rod-shaped block copolymer of poly(2-vinylpyridine)-block-poly(n-hexylisocyanate) or coil-coil-shaped block copolymer of poly(2-vinylpyridine)-block-poly(styrene) is an amphiphilic polymer having both hydrophilic and hydrophobic groups, and is thus suitable for self-assembly. Hence, the copolymer could form a uniform micelle-structure nano particle or a phase-separated lamella nano structure depending on choice of the selective solvent. A several nanometer-sized uniform crystalline structure could be obtained from a polymer nano structure, and various results could be obtained by differing aspects such as a distance between crystals by adjusting the concentration of the block copolymer (main chain), the molar ratio of the main chain to the side chain, the kind of the organic solvent and the amounts of additives.

### Preparation Example 1

### Preparation of block copolymer of poly(2-vinylpyridine)-block-poly(n-hexylisocyanate) (P2VP-b-PHIC)

To synthesize a block copolymer of P2VP-b-PHIC, polymerization was performed with 2-vinylpyridine as a first monomer in the solvent of tetrahydrofurane (THF) at −78° C. under a high vacuum of 10−6 torr for 30 minutes. The temperature was cooled down to −78° C. by adding dry ice in a constant-temperature bath with acetone.

A polymerization reactor including glass ampoules containing a purified initiator (DPM-K), monomers (2VP and n-HIC), additives (sodium tetraphenylborate; NaBPh4), a terminating agent (methanol-acetic acid) and a washing solution, was sealed off from the vacuum line. The sealed reactor was washed by the ampoule containing the washing solution, and then the initiator was introduced into the polymerization reactor by breaking its ampoule. The polymerization reactor was placed in the constant-temperature bath with acetone to reach temperature equilibrium (−78° C.), and 2VP was introduced thereto and reacted for 30 minutes.

After that, some of the poly(2-vinylpyridine) homopolymer solution was transferred to a tube for homopolymer, and the additive, sodium tetraphenylborate, was introduced into a main reactor to convert a counter cation into a sodium ion from a potassium ion. The reactor was transferred to the constant-temperature bath which is set to −98° C. by adding liquid nitrogen to methanol to reach temperature equilibrium. Then, n-hexylisocyanate, a second monomer, was introduced into the reactor and reacted for 20 minutes.

The polymerization was terminated by adding a methanol-acetic acid mixture as a terminating agent. The polymer thus obtained was precipitated in excess methanol and dried by vacuum-drying or freeze-drying.

### Preparation Example 2

### Preparation of block copolymer of poly(2-vinylpridine)-block-polystyrene (P2VP-b-PS)

To synthesize P2VP-b-PS block copolymer of Formula 2, polymerization was performed using styrene as a first monomer at −78° C. in a THF solvent in an atmosphere of nitrogen. The temperature was cooled down to −78° C. by adding dry ice in a constant-temperature bath with acetone.

First, an initiator of sec-butyl lithium was added to initiate the polymerization of styrene dissolved in the THF solvent. The polymerization was performed for 30 minutes. After that, to weaken activity of a living polystyryl anion, an additive of 1,1-diphenyl ethylene solution was dissolved in the polystyrene solution. The reaction was performed for 30 minutes. Then, a 2VP solution was added to the polystyrene solution for second polymerization. After terminating the reaction, a resulting polymer was precipitated in excess methanol and hexane, and melted in benzene, followed by freeze-drying the mixture.

Schemes 1 to 6 are examples of cross-linking and quaternizing with 1,4-dibromobutane or 1-bromobutane side chain using a block copolymer template.

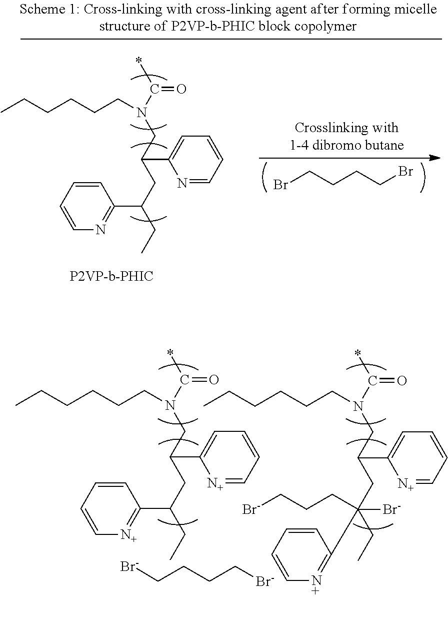

A P2VP-b-PHIC block copolymer prepared according to Example 1 was added to a mixed solvent of methanol and THF or toluene and THF in a volume ratio of 8:2, and agitated at a constant speed for 10 hours.

Afterward, 100 mole % cross-linking agent (1,4-dibromobutane of Formula 13), calculated based on the mole of a vinyl pyridine unit from poly(2-vinylpyridine) of the block copolymer, was dispersed in the polymer micelle solution prepared from the block copolymer by the method described above, and agitated for 24 to 180 hours depending on the kind of the cross-linking agent.

The block copolymer cross-linked with the vinyl pyridine unit from the poly(2-vinylpyridine) of the block copolymer and a micelle template formed a film whose structure and physical properties were then analyzed using FE-TEM, FE-SEM, XRD and DLS equipment.

The block copolymer thus prepared had a molecular weight of 26.2 kg/mol and a P2VP mole fraction of 0.85. The copolymer was dissolved in a mixed solvent of methanol and THF in a volume ratio of 8:2 to a concentration of from 0.2 to 10 g/l. Here, 100 mole % of cross-linking agent (1,4-dibromobutane) based on the mole of the vinyl pyridine unit from poly(2-vinyl pyridine) of the block copolymer was used.

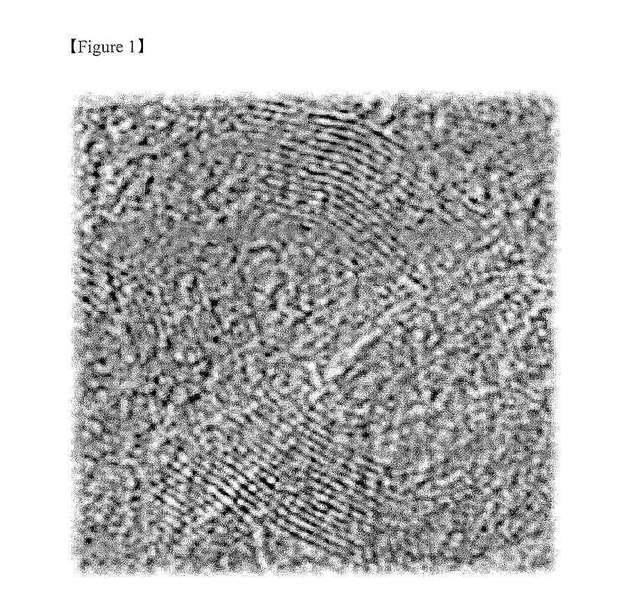

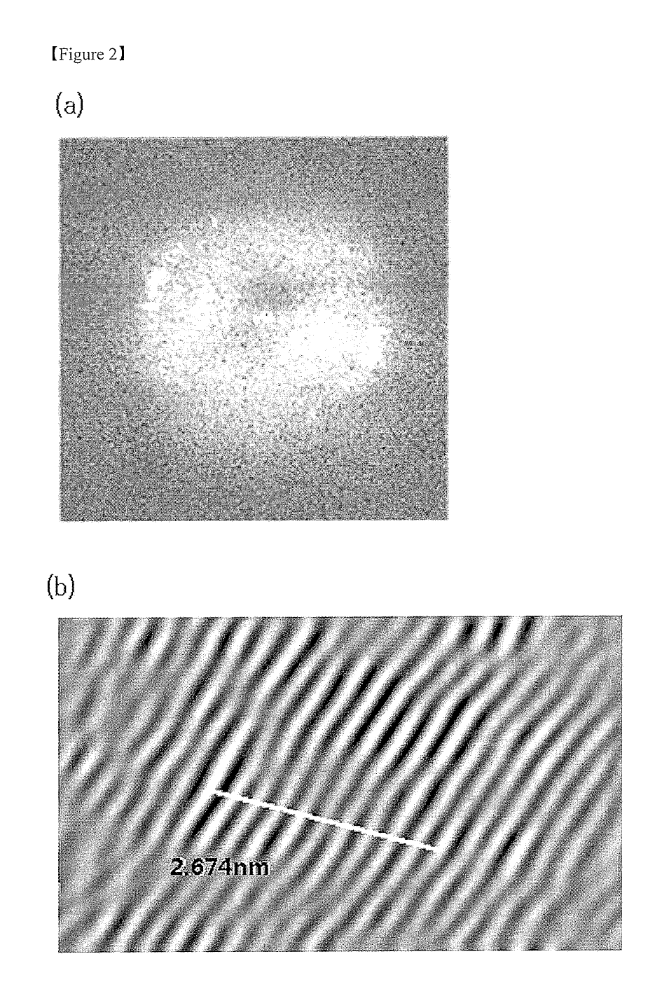

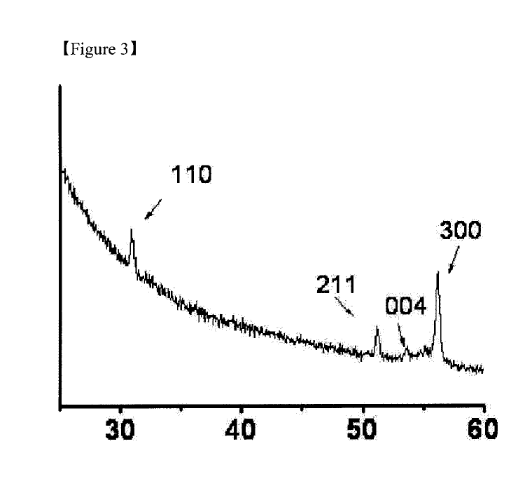

As seen from the high-resolution (HR)-TEM image and its Fast Fourier Transform for the cross-linked micelle of FIGS. 1 and 2, a P2VP domain is placed outside the micelle, whereas a PHIC domain is placed inside the micelle, and a distance between pattern lines is 0.267 nm in the P2VP domain of the micelle, which corresponds to the XRD result of FIG. 3.

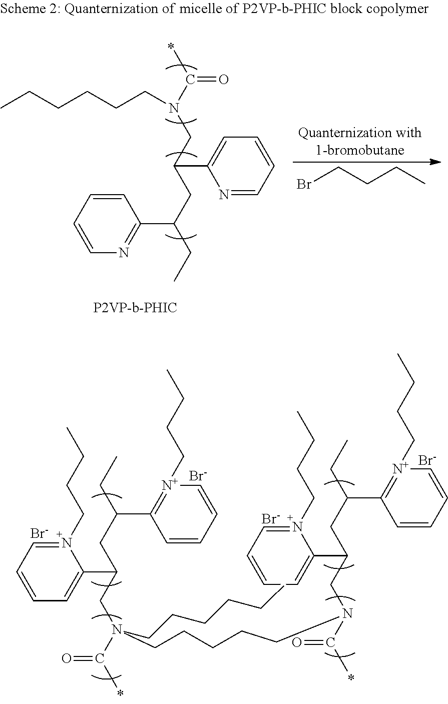

The P2VP-b-PHIC copolymer prepared according to Preparation example 1 was added to a mixed solvent of toluene and THF in a volume ratio of 8:2, and agitated at a constant speed for 10 hours.

Afterward, a specific amount of 1-bromobutane of Formula 14, calculated by considering the mole fraction of the vinylpyridine unit from poly(2-vinylpyridine) of the block copolymer, was dispersed in the polymer micelle solution prepared from the block copolymer by the method described above, and agitated at a constant speed for 10 hours. Through these procedures, nitrogen from pyridine of the block copolymer was quaternized with bromine from 1-bromobutane.

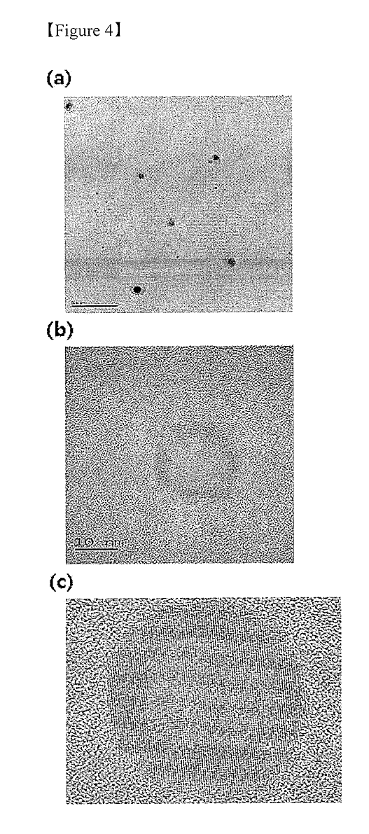

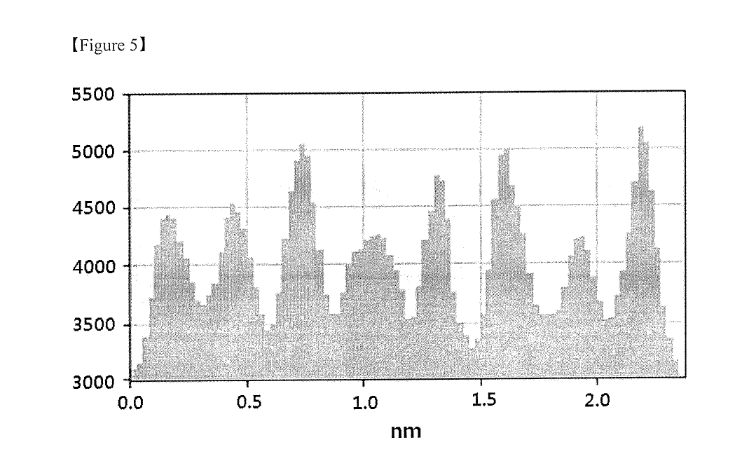

FIG. 4 shows a crystalline structure of P2VP-b-PHIC micelle quaternized by the above procedures. As seen from the density distribution of fringe spacings in FIG. 5, a distance between crystals is maintained at an average of 0.275 nm.

### Scheme 3: Cross-Linking of Large-Sized Polymer Film-Type Nano Structure Using P2VP-b-PHIC Block Copolymer

The present example is almost the same as Scheme 2, other than the kinds of a solvent used. That is, depending on a solvent used, a film-type structure, other than the micelle-type structure, can be formed.

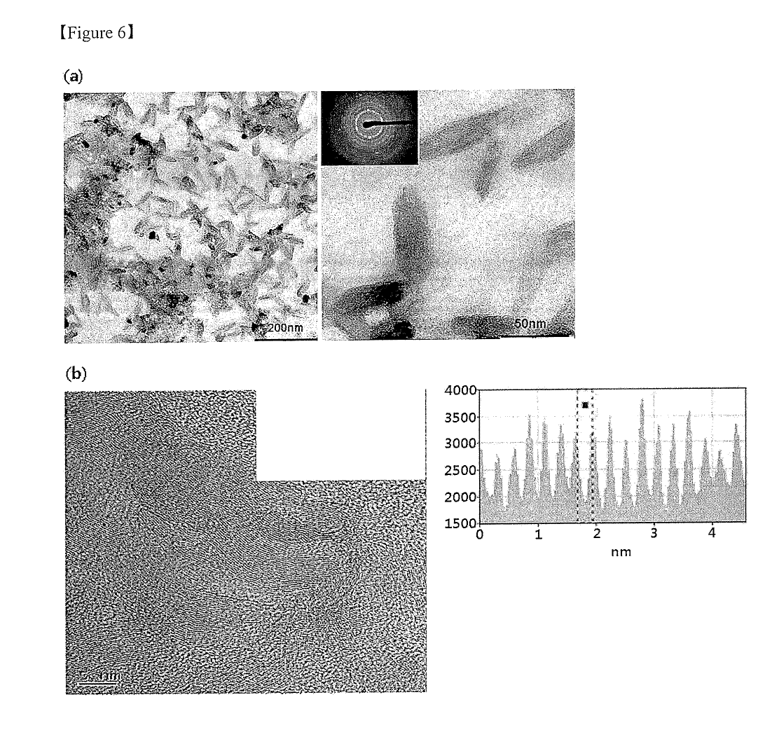

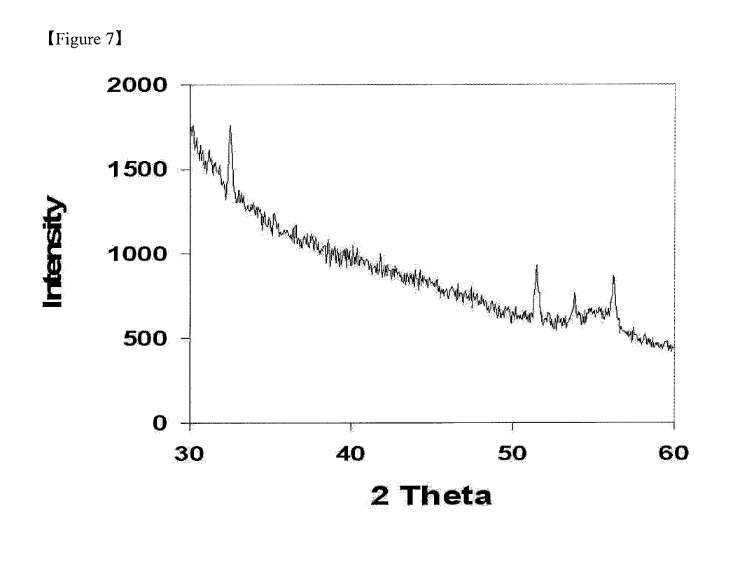

The block copolymer (P2VP-b-PHIC) prepared according to Preparation example 1 was dispersed in the solvent of THF in a concentration of 0.1 to 1 mg/ml, and agitated at a constant speed for 10 hours. In consideration of the mole fraction of the vinylpyridine unit from poly(2-vinylpyridine) of the block copolymer, a specific amount of 1-bromobutane (Formula 14) was dispersed in the polymer micelle solution prepared from the block copolymer by the method described above, and then agitated at a constant speed for 10 hours. Through these procedures, nitrogen from pyridine of the block copolymer was quaternized with bromine from 1-bromobutane. FIG. 6(a) shows an EF-TEM image and its XRD result for the polymer film formed by quaternizing P2VP-b-PHIC dispersed in the THF solvent in a concentration of 0.1 to 1 mg/ml with 1-dibromobutane, and FIG. 6(b) shows an HR-TEM image and a density distribution of fringe spacings in the polymer nano crystalline structure. FIG. 7 shows an XRD result for the quaternized polymer film.

Scheme 4: Zipper Mechanism According to Amount of Cross-Linking Agent after Forming Micelle of P2VP-b-PHIC Block Copolymer

A zipper mechanism used herein is an approach for partially or completely forming cross-links between block copolymer, homopolymer or monomer main chains having cross-linkable functional groups, e.g., a pyridine, thiophene or thiazole group and the side chain material by changing molar ratios of the main chain material to side chain material.

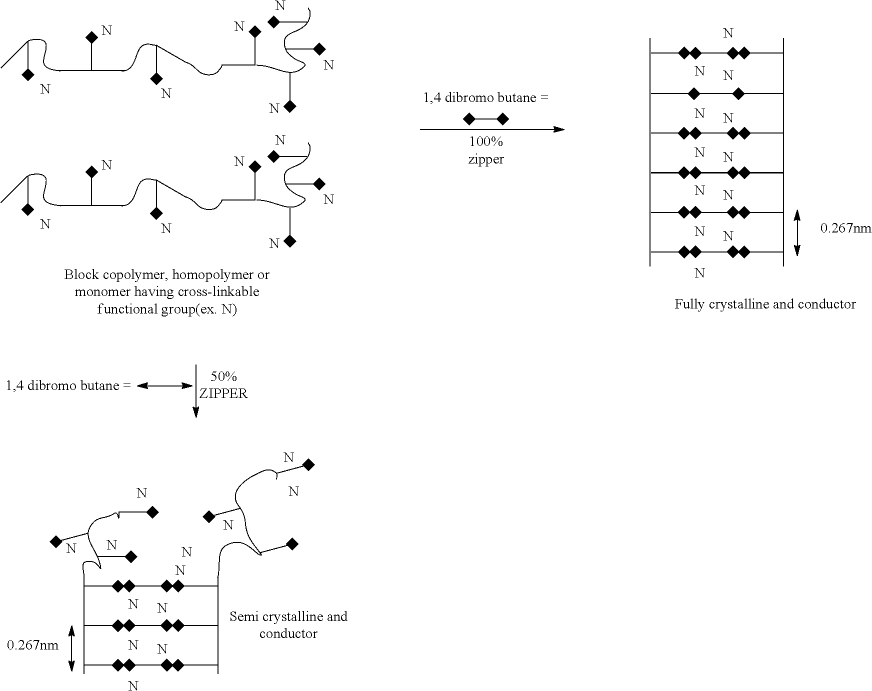

That is, when a block copolymer having a cross-linkable functional group was present in the solution in the following reaction formula, polymer chains formed from block copolymer were combined with the aid of adjacent side chains like zippers according to the amounts of the main chain material and the side chain material.

The P2VP-b-PHIC block copolymer prepared according to Preparation example 1 is added to a mixed solvent of methanol and THF or toluene and THF in a volume ratio of 8:2, and agitated at a constant speed for 10 hours. Afterward, 50, 75 and 100 mole % of cross-linking agents (1,4-dibromobutane), calculated based on the mole of the vinyl pyridine unit from poly(2-vinylpyridine) of the block copolymer, were dispersed in the polymer micelle solution prepared from the block copolymer by the method described above, and agitated from 24 to 180 hours depending on the kind of the cross-linking agents. Thus, from the results combined by the zipper mechanism, it can be seen that the amount of the nano crystalline structure observed in the P2VP domain can be dependant on the amount of the dispersed cross-linking agent.

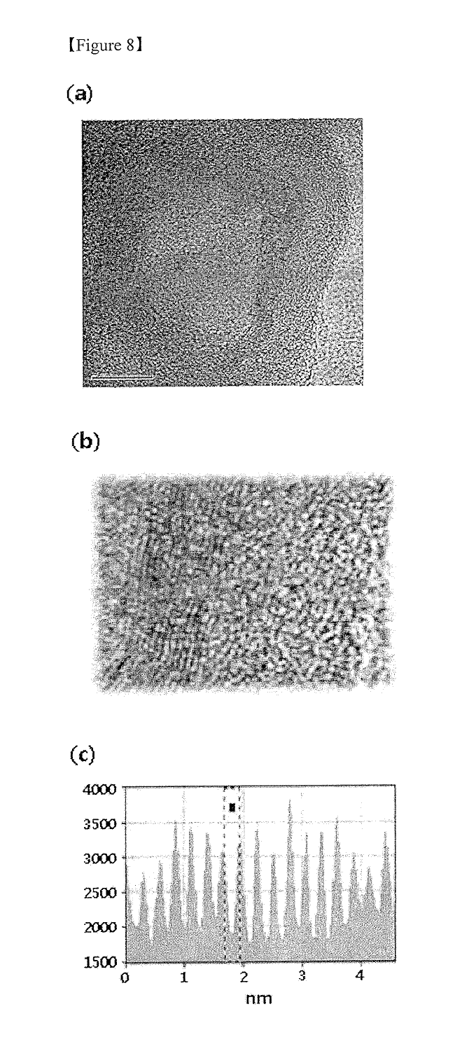

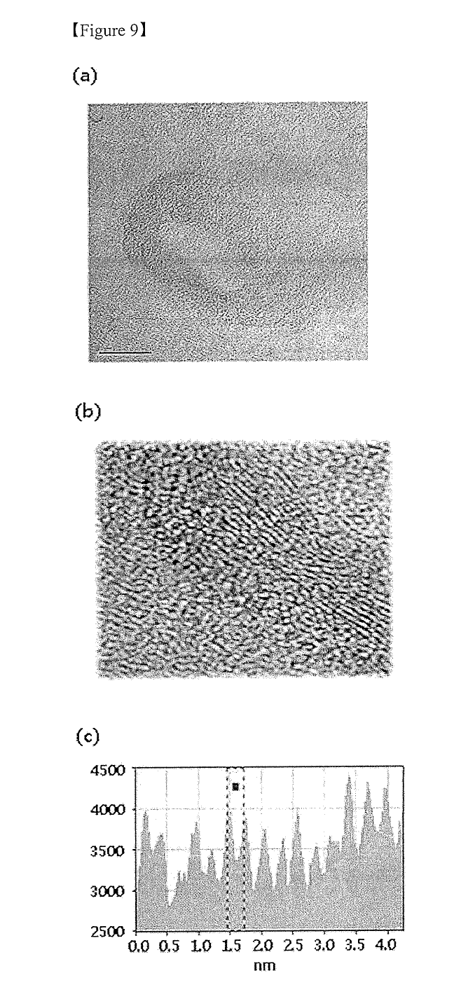

That is, FIG. 1 shows results obtained using 100 mole % of the cross-linking agent, FIG. 8 shows results obtained using 75 mole % of cross-linking agent, and FIG. 9 shows results obtained using 50 mole % of cross-linking agent based on the mole of the vinyl pyridine unit. In the case of 100 mole % of cross-linking agent, the nano crystalline structure can be observed in a larger area of the P2VP domain, whereas in the case of 50% cross-linking agent, the nano crystalline structure can be observed in a smaller area.

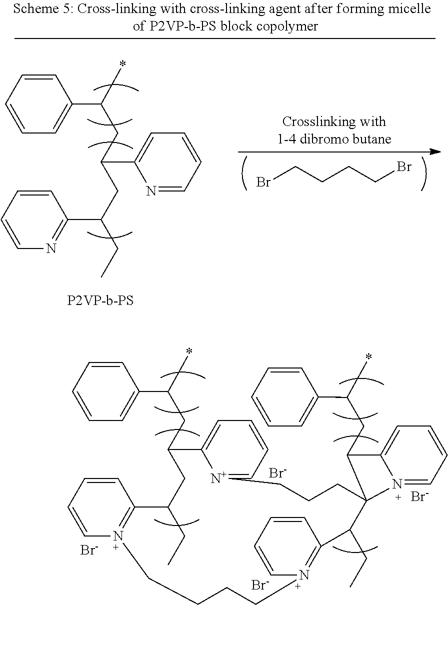

The P2VP-b-PS block copolymer prepared according to Preparation example 2 was dissolved in a 100% pure methanol solvent and then agitated at a constant speed for 10 hours. After that, 100 mole % of cross-linking agent (1,4-dibromobutane), based on the mole of the vinyl pyridine unit from the poly(2-vinyl pyridine) of the block copolymer, was dispersed in the polymer micelle solution prepared from the block copolymer by the method described above, and then agitated for 24 to 180 hours depending on the kind of the cross-linking agent.

The block copolymer thus prepared had a molecular weight of 120 kg/mol and a P2VP mole fraction of 0.50. The block polymer was dissolved in a mixed solvent of methanol and THF in a volume ratio of 8:2 to a concentration of from 0.2 to 10 g/l. Here, 50, 75 and 100 mole % of cross-linking agents based on the mole of the vinyl pyridine unit from poly(2-vinyl pyridine) of the block copolymer were used.

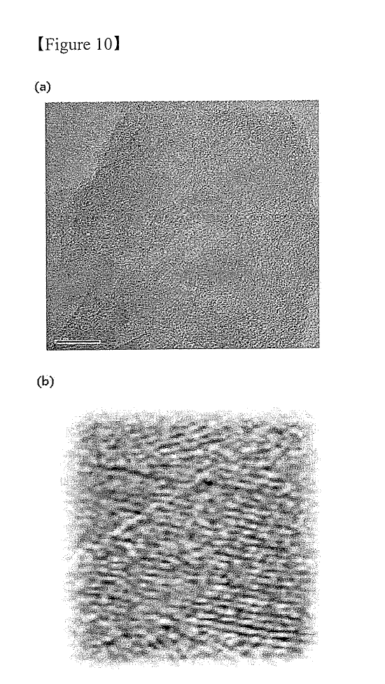

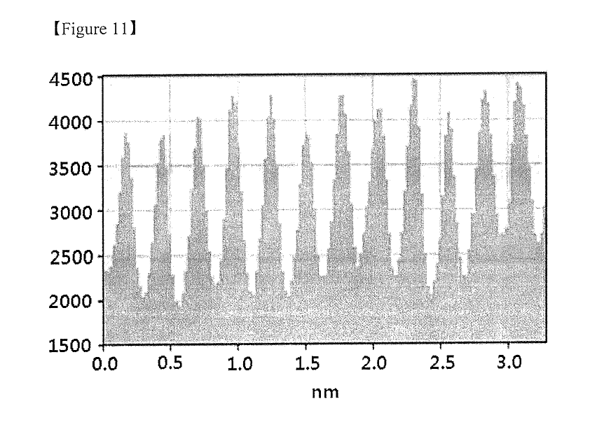

FIG. 10 shows an HR-TEM image for P2VP-b-PS block copolymer after cross-linking. From the results, it can be seen that the P2VP domain is placed outside the micelle structure, whereas the PS domain is placed inside the micelle structure. It can be seen from the density distribution of fringe spacings shown in FIG. 11 that fringe spacing is 0.276 nm.

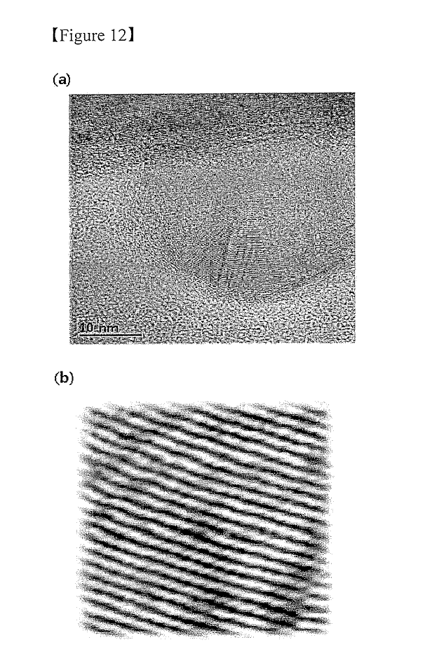

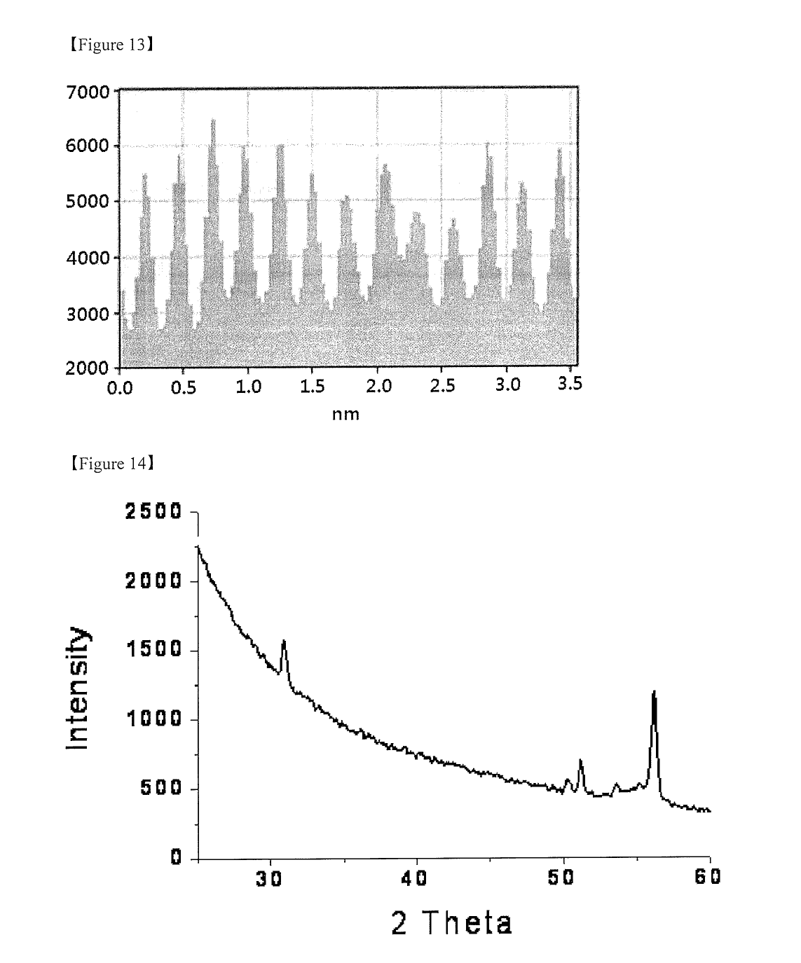

In the mixed solvent of toluene and methanol in a volume ratio of 8:2, according to FIG. 12, the P2VP domain is placed inside the micelle structure, whereas the PS domain is placed outside the micelle structure. According to the density distribution of fringe spacings, the fringe spacing is 0.276 nm.

Scheme 6: Formation of Polymer Nano Thin Film Structure by Cross-Linking of poly(phenyl-2-vinylpyridine)-block-poly(2-vinlypyridine) (PP2VP-b-P2VP) Block Copolymer

0.5 to 5 mg/ml of PP2VP-b-P2VP block copolymer was dissolved in the solvent of THF and agitated at a constant speed for 10 hours. After that, a specific amount of 1,4-dibromobutane, calculated based on the mole of the vinyl pyridine unit from poly(2-vinyl pyridine) of the block copolymer, was dispersed in the polymer solution prepared from the block copolymer by the method described above, and agitated at a constant speed for 10 hours. Through the above procedure, quaternization between bromine from 1, 4-dibromobutane and nitrogen from pyridine of the block copolymer was achieved.

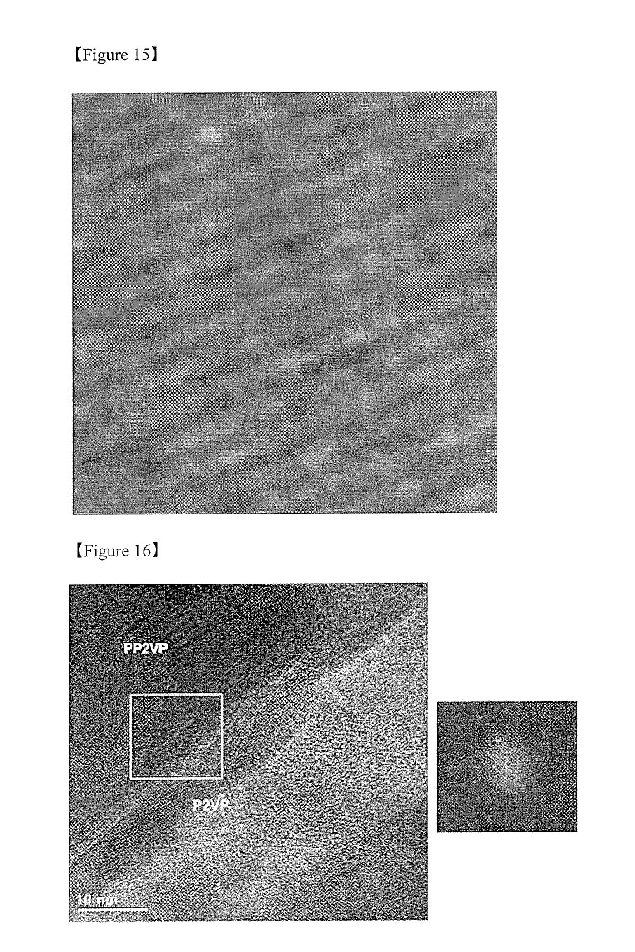

FIG. 15 shows an AFM image for a polymer film cross-linked with 1, 5-dibrombutne in the PP2VP-b-P2VP block copolymer dissolved in the THF solvent. FIG. 16 shows an HR-TEM image and an XRD result for the product of the above procedure.

### Example 2

### Formation of Organic Crystalline Structure Using Homopolymer

In the present embodiment, Schemes 7 and 8 show examples of reaction between a side chain and a homopolymer main chain.

To nano-crystallize homopolymers of Formulae 4 to 8 for a main chain, the homopolymer was mixed with an intermediate material for a side chain (Formulae 12 to 17) in a ratio of 1:1, nitrogen gas was injected into the mixture, and the mixture was agitated at room temperature to induce interaction between functional groups of the homopolymer and the side chain material by quaternization, cross-linking, hydrogen bonding or metal cooperation.

After agitation, the mixture was coated on a silicon wafer. Here, to give crystallinity, the mixture coated on the silicon wafer was stored at room temperature for three days to slowly evaporate a solvent. Then, a film from which the solvent was slowly evaporated was dried in an oven at 60° C. for 6 hours.

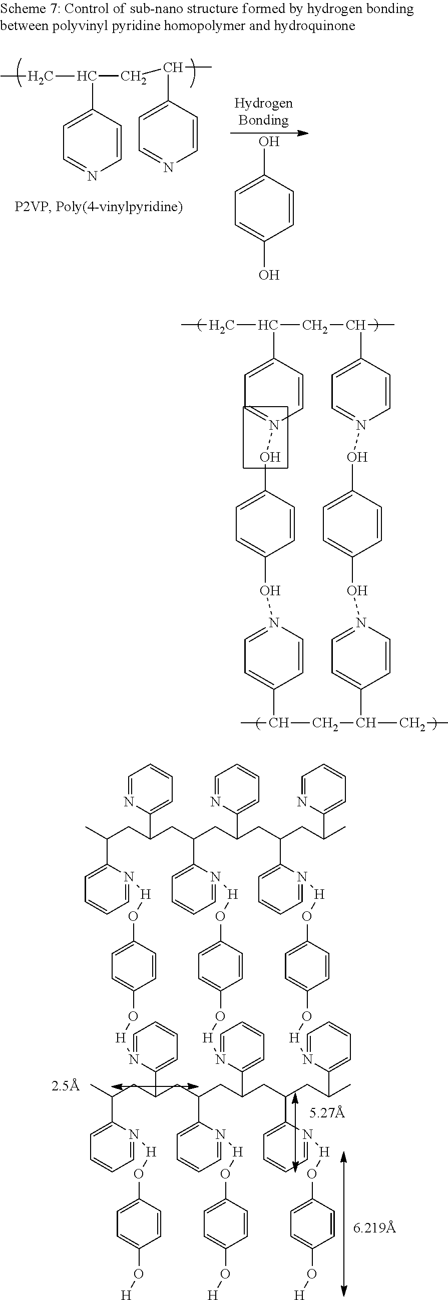

Hydroquinone (Formula 15) was added to poly(2-vinylpyridine) of Formula 6 and poly(4-vinyl pyridine) of Formula 7, respectively, in the solvent of methanol, and then agitated at a constant speed for 10 hours. Here, the molar ratio of pyridine to hydroquinone is 1:1, and the agitation was performed in an atmosphere of nitrogen gas at room temperature to form hydrogen bonding between nitrogen from the pyridine and an alcoholic group from the hydroquinone. After that, the mixture was coated on a silicon wafer. Here, to give crystallinity, the mixture coated on the silicon wafer was stored for three days at room temperature to slowly evaporate the solvent therefrom. A film formed by slowly evaporating the solvent for three days was dried in an oven at 60° C. for 6 hours.

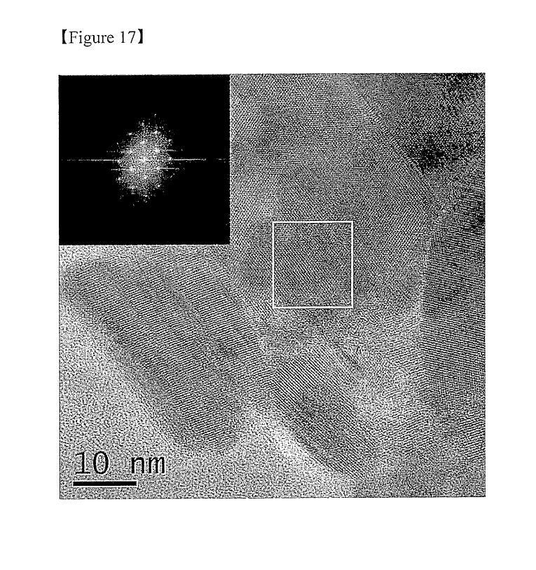

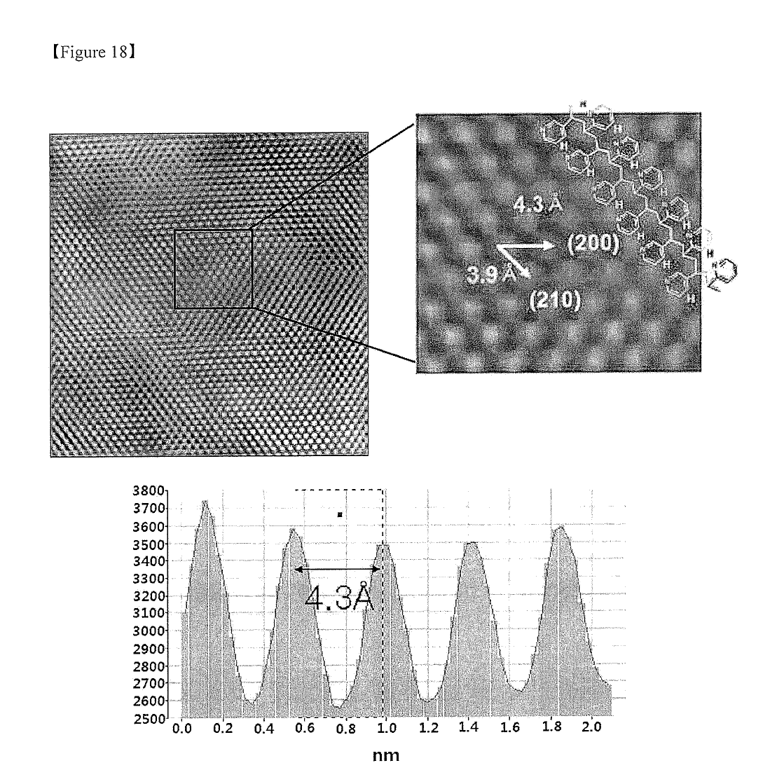

The crystallinity and sub-nano structure of the film thus obtained were analyzed by XRD and HR-TEM. The XRD result reveals that both amorphous polymers, i.e., poly(2-vinyl pyridine) and poly(4-vinyl pyridine), were combined with hydroquinone by hydrogen bonding and exhibited crystallinity, and the HR-TEM result reveals a lattice image in the sub-nano structure. And, XRD peaks closely match the crystalline structure observed from the HR-TEM lattice image. FIG. 17 shows an HR-TEM image and an XRD result for a nano crystalline structure of a monomer film cross-linked with hydroquinone by hydrogen bonding in poly(2-vinylpyridine) dispersed in the methanol solvent. FIG. 18 shows a Fast Fourier Transform (FFT) of the HR-TEM image and the density distribution of fringe spacings in a nano crystalline structure of the monomer film.

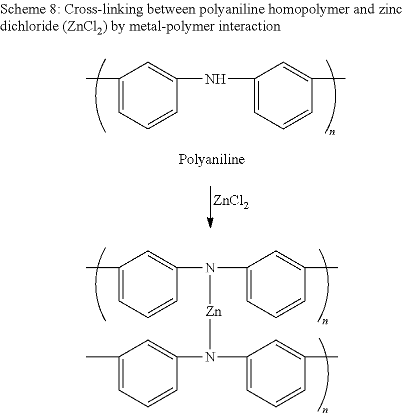

The same amount of ZnCl₂ as a nitrogen unit from polyaniline (Formula 8) was dissolved in a THF solvent and agitated in an atmosphere of nitrogen gas at a constant speed for 10 hours. Through the above procedure, the polymer-metal interaction between a halogenic group from the metal and nitrogen from the polymer was induced. After agitation, the mixture was coated on a silicon wafer. Here, to give crystallinity, the mixture coated on the silicon wafer was stored at room temperature for three days to slowly evaporate the solvent therefrom. The resulting film from which the solvent was slowly evaporated for three days was dried in an oven at 60° C. for 6 hours.

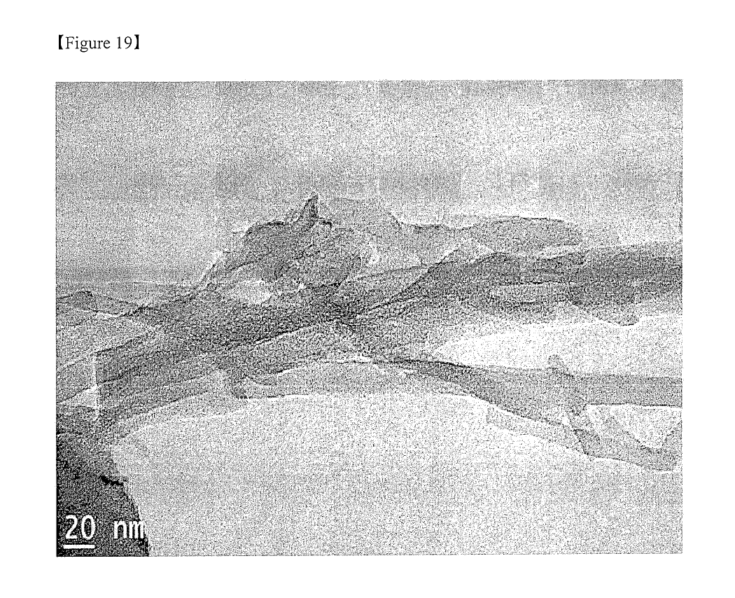

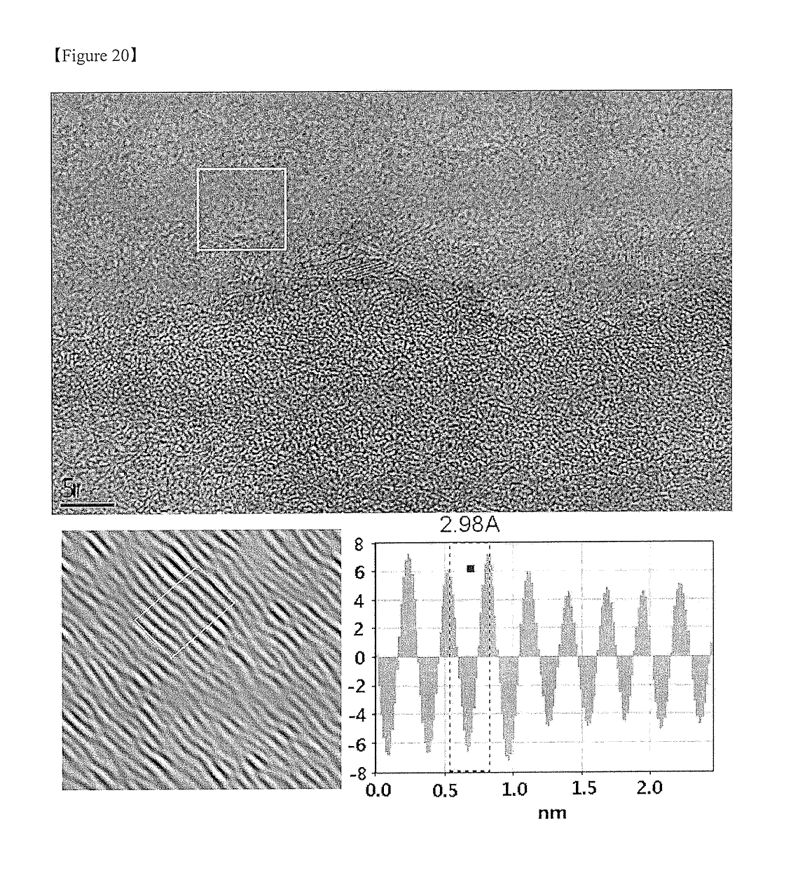

FIG. 19 shows an EF-TEM image of a rod-shaped polymer film cross-linked with ZnCl₂ by metal-polymer interaction in polyaniline. FIG. 20 shows an FFT of the HR-TEM image of the polymer film and a density distribution of fringe spacings in the nano crystalline structure.

### Example 3

### Formation of Organic Crystalline Structure Using Monomer

To nano-crystallize organic monomers of Formulae 9 to 11, a monomer for an organic main chain such as 2,2-bipyridine, and an intermediate for a side chain such as 1,4-dibromobutane, were dissolved in a selective solvent in a molar ratio of 1:1, and then the mixture was reacted at 120° C. for 48 hours. When the reaction terminated, the solvent was removed, and uncoupled dibromobutane and bipyridine were also removed. Here, the mixture was coated on a silicon wafer and then the solvent was slowly evaporated at room temperature for three days. The resulting film from which the solvent was slowly evaporated for three days is dried in an oven at 60° C. for 6 hours.

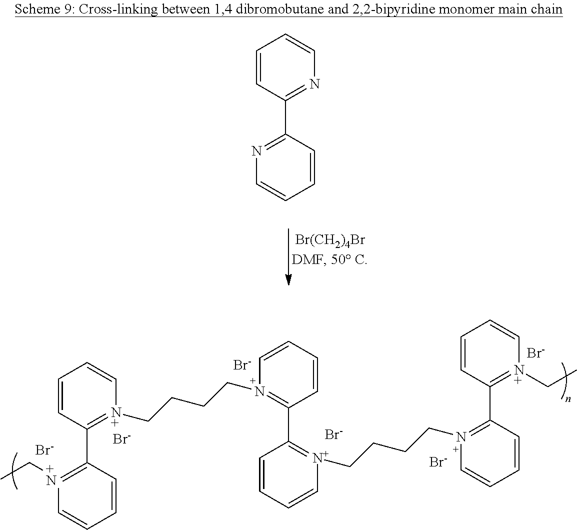

2,2-bipyridine of Formula 10 was mixed with 1,4-dibromobutane of Formula 13 in a DMF solvent in a molar ratio of 1:1, and the mixture was reacted at 120° C. for 48 hours. After the reaction finished, the DMF solvent was removed, and then uncoupled dibromobutane and bipyridine were removed by dialysis (membrane: Regenerated Cellulose MWCO:3500) in an atmosphere of MeOH for five days.

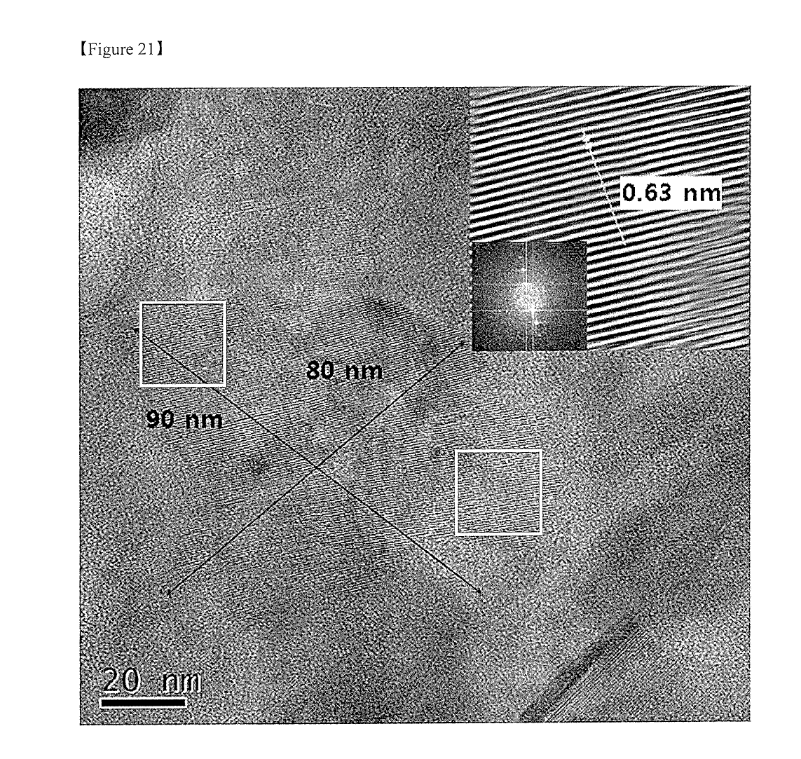

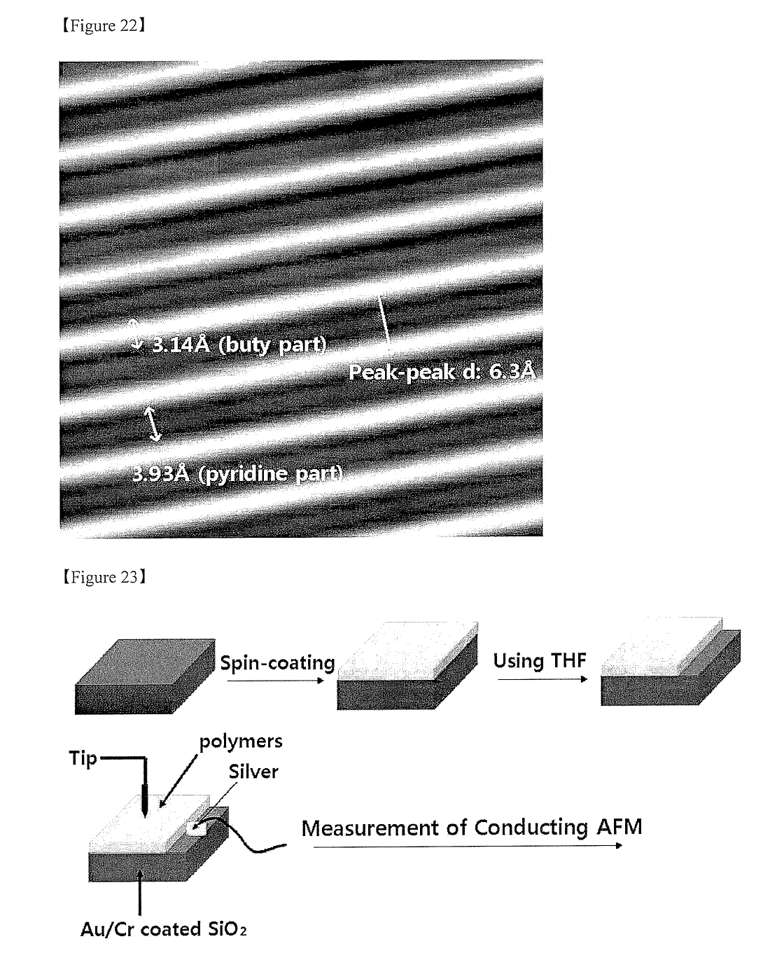

FIG. 21 shows an HR-TEM image, an FFT thereof and a diffraction result for a nano crystalline structure of a monomer film cross-linked with 1,4-dibromobutane in 2,2-bipyridine dispersed in the DMF solvent. FIG. 22 shows an FFT from the HR-TEM image and its enlarged image for the nano crystalline structure of the cross-linked monomer film.

### Example 4

### Cross-Linking Between 1,4-Dibromobutane as Side Chain and P2VP, PP2VP and PPP2VP Homopolymer as Main Chain and Film Formed by Cross-Linking

P2VP, PP2VP and PPP2VP were mixed with 1,4-dibromodutane in THF solvents in a molar ratio of 1:1, and the mixtures were agitated at a constant speed for 10 hours. The agitation was performed in an atmosphere of nitrogen gas at room temperature to induce cross-linking between nitrogen from pyridine and bromine from 1,4-dibromobutane. After that, the mixture was coated on a silicon wafer. Here, in order to give crystallinity, the solution coated on the silicon wafer was stored at room temperature for three days to slowly evaporate the solvent therefrom. The resulting film from which the solvent was evaporated for three days was dried in an oven at 60° C. for 6 hours to yield a crystalline film.

FIG. 23 shows a technique of measuring electrical characteristics of a polymer film having an organic crystalline structure formed according to the present embodiment. Referring to FIG. 23, first, a gold/chromium layer is formed on a silicon substrate by chemical vapor deposition (CVD). Subsequently, a polymer solution is dropped on a substrate having the gold/chromium layer, and spin coating is performed. After the spin coating, the polymer solution is cured at about 100° C. To introduce a silver electrode to a part of the polymer-coated substrate, one surface of the substrate is removed using tetrahydrofuran (THF), an organic solvent. Silver is introduced into the removed surface, and then electrical characteristics of organic single crystalline polymers having P2VP, PP2VP and PPP2VP as main chain materials are estimated.

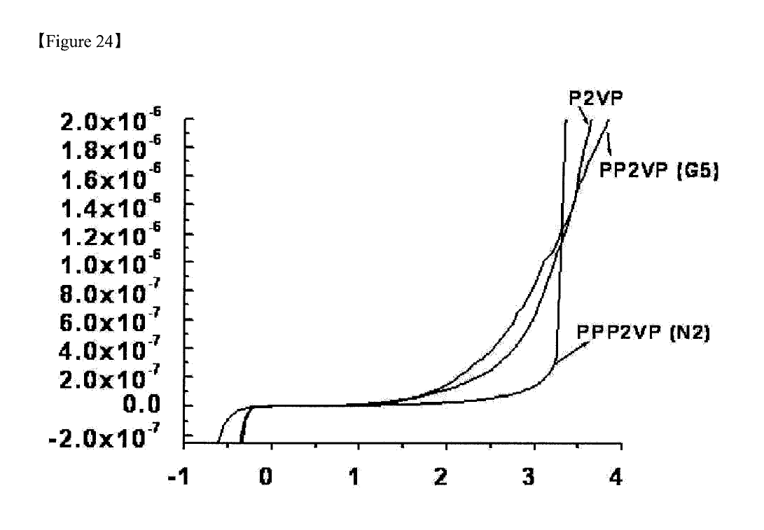

FIG. 24 is a graph showing electrical characteristics of organic single crystalline polymers according to a fourth exemplary embodiment of the present invention.

Referring to FIG. 24, a thin film formed of an organic crystalline polymer has electrical characteristics of a diode. That is, at a voltage of about 2V, the current through a device is substantially 0, whereas at a voltage of 3.2V, the current through a device drastically increases. That is, the device maintains the “off” state at 2V or less, and maintains the “on” state at 3.2V or more. Particularly, PPP2VP having relatively a large amount of a phenyl group has excellent diode characteristics.

As described above, the organic crystalline polymer according to the present embodiment exhibits excellent diode characteristics.

While the invention has been shown and described with reference to certain exemplary embodiments thereof, it will be understood by those skilled in the art that various changes in form and details may be made therein without departing from the spirit and scope of the invention as defined by the appended claims.

1. An organic crystalline polymer, comprising:
a main chain material having a functional group enabling quaternization, cross-linking, organic material-metal interaction or hydrogen bonding; and
a side chain material combining with the adjacent main chain material at the functional group by quaternization, cross-linking, organic material-metal interaction or hydrogen bonding.

2. The organic crystalline polymer according to claim 1, wherein the functional group of the main chain material includes pyridines, pyrroles and thiophenes.

3. The organic crystalline polymer according to claim 2, wherein the pyridines include pyridine, pyridazine, pyrimidine, triazine, tetrazine, oxazine, thiazine and selenazine, the pyrolles include pyrrole, pyrazole, imidazole, dihydrothiazole, dihydrooxazole, dihydroselenazole, triazole, dihydrooxadiazole, dihydrothiadiazole and dihydroselenadiazole, and the thiophenes include thiophene, isothiazole, thiazole, dithiole, oxathiole, thiaselenaole, thiadiazole, oxathiazole, dithiazole and thiaselenazole.

4. The organic crystalline polymer according to claim 1, wherein the functional group of the main chain material is a block copolymer, homopolymer or organic monomer including a nitrogen, sulfur or selenium atom.

5. The organic crystalline polymer according to claim 4, wherein the main chain material has one of the compositions of Formulae 1 to 12, and the side chain material has one of the compositions of Formulae 13 to 19.

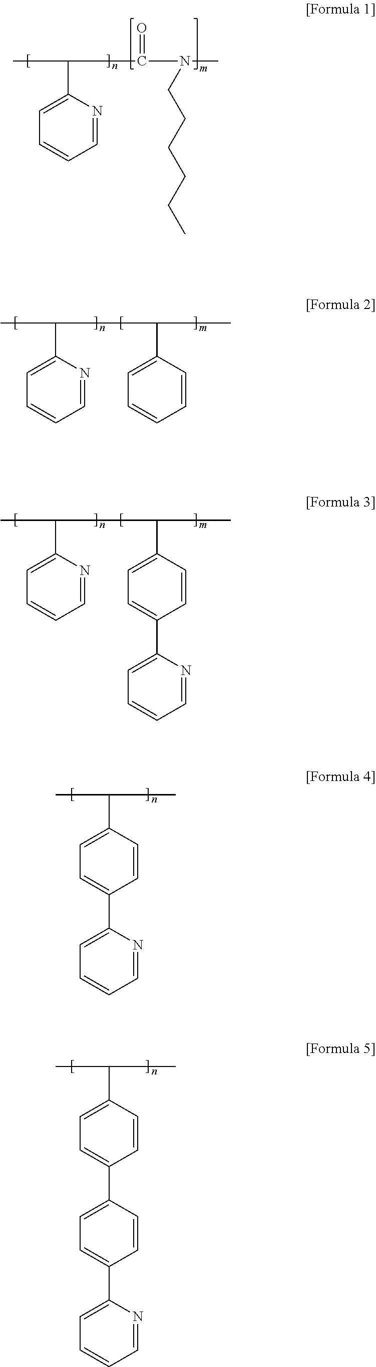

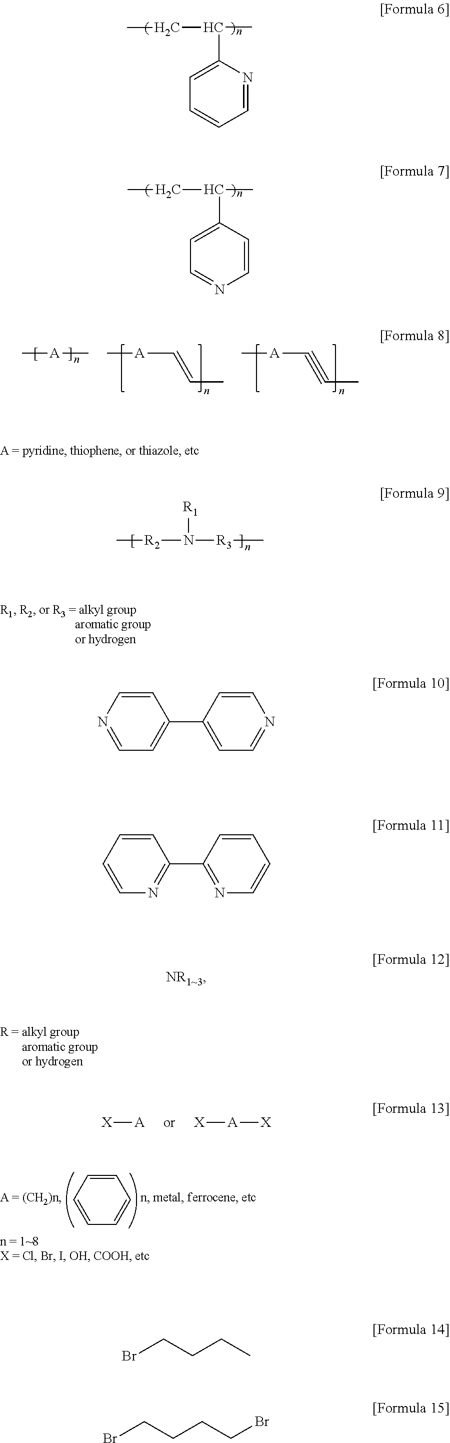

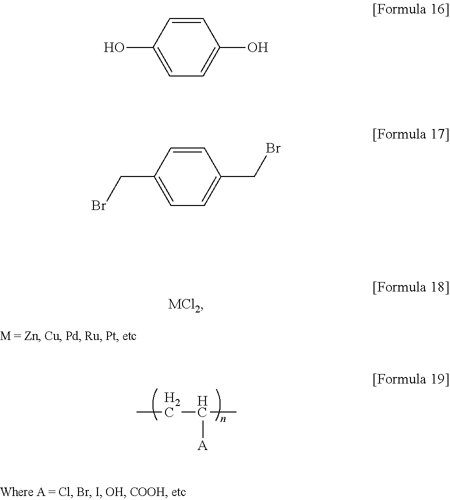

6. The organic crystalline polymer according to claim 1, wherein the side chain material is introduced into the main chain material having the functional group dissolved in a solution to form a crystalline structure through a zipper mechanism in which the main chain materials are combined with the aid of the side chain materials like zippers by cross-linking, quaternization, organic material-metal interaction or hydrogen bonding, depending on amounts of the main and side chain materials.

7. An organic crystalline polymer, comprising:
a main chain material having a functional group containing a nitrogen, sulfur or selenium atom with an unshared electron pair to perform quaternization, cross-linking, organic material-metal interaction or hydrogen bonding; and
a side chain material combining with the functional group of the adjacent main chain material by quaternization, cross-linking, organic material-metal interaction or hydrogen bonding.

8. The organic crystalline polymer according to claim 7, wherein the functional group of the main chain material includes pyridines, pyrroles and thiophenes, and the side chain material has at least one of the compositions of Formulae 13 to 19. [chemical structure]
